(19) United States
(12) Patent Application Publication
(10) Pub. No.: US 2025/0264865 A1
(43) Pub. Date: Aug. 21, 2025

(54) WIRELESSHART CONNECTIVITY FOR CIRCUIT BREAKERS IN AN EXPLOSION-PROOF HOUSING FOR HEALTH/PERFORMANCE MONITORING

(71) Applicant: APPLETON GRP LLC, Rosemont, IL (US)

(72) Inventors: Timothy E. Graff, Arlington Heights, IL (US); Ravindra Viraj Gurjar, Pune (IN)

(21) Appl. No.: 18/742,300

(22) Filed: Jun. 13, 2024

(30) Foreign Application Priority Data
Feb. 16, 2024 (IN) 202421011049

(51) Int. Cl. G05B 19/418; H01H 71/02

(52) U.S. Cl. CPC G05B 19/4185; H01H 71/0257; H01H 2231/016; H01H 2231/032

(57) ABSTRACT

A controller may be positioned within an explosion-proof housing in a process control system. The controller may be connected to circuit breakers within the explosion-proof housing via wired communication links, and connected to devices positioned external to the explosion-proof housing via wireless communication links. The wireless communication links may have lower bandwidth than the wired communication links. The controller may include one or more processors and one or more memories storing a set of computer-executable instructions that cause the controller to: receive, from the breakers via the wired communication links, data associated with the operation of the circuit breakers; generate messages based on the data associated with the operation of the circuit breakers; and send, via the wireless communication links, the messages to the devices positioned external to the explosion-proof housing.

### CROSS REFERENCE TO RELATED APPLICATIONS

This application claims priority to Indian Patent Application number 202421011049, which was filed on Feb. 16, 2024, and is entitled “WirelessHART Connectivity for Circuit Breakers in an Explosion Proof Housing for Health/Performance Monitoring,” the entire contents of which are hereby incorporated by reference.

### FIELD OF THE DISCLOSURE

This disclosure relates to wireless connectivity (e.g., using WirelessHART®) for circuit breakers in an explosion-proof housing of an industrial environment for health and/or performance monitoring.

### BACKGROUND

The background description provided within this document is for the purpose of generally presenting the context of the disclosure. Work of the presently named inventors, to the extent described in this background section, as well as aspects of the description that may not otherwise qualify as prior art at the time of filing, are neither expressly nor impliedly admitted as prior art against the present disclosure.

A circuit breaker associated with an industrial system (e.g., a process control system, a luminaire system, or any other system within an industrial environment) may be opened to cut off power to field devices in the industrial environment, equipment in the industrial environment (e.g., pipe heat tracing, pumps and fans used throughout the industrial facility), other devices in the industrial environment, etc., and closed to provide power to the one or more the field devices in the industrial environment, equipment in the industrial environment, other devices in the industrial environment, etc., Circuit breakers that are associated with systems in hazardous industrial environments may be positioned within explosion-proof housings to meet safety requirements. While typical circuit breakers in such hazardous industrial environments are capable of some level of event recording, these events are typically recorded on a local memory only, with key events reported locally via a light indicator (or sometimes an audio indicator). To access these circuit breakers and the data/memory associated therewith (e.g., to access data captured by the circuit breakers or sensors associated therewith, to change the configuration of the circuit breakers, to re-set the circuit breakers, etc.), a worker in the industrial environment must obtain a permit and physically open the explosion-proof housing where the circuit breakers are positioned, and pull data cables out of the explosion-proof housing.

Consequently, workers must physically approach and manually access the circuit breakers within the explosion-proof housing in order to be notified of any circuit breaker safety and/or performance issues that may arise, and may not be notified/informed of such issues in a timely manner. For example, over a period of time, the explosion-proof housing may develop issues due to gasket degradation, leading to water ingress or excessive heat buildup that may result in a safety hazard. Even if the circuit breakers log these issues, workers within the plant may not be notified of such issues until they are able to physically open the explosion-proof housing, which may be a long time after such issues initially arise, in some cases resulting in more hazardous conditions in the industrial environment.

### SUMMARY

Many industrial environments utilize one or more wired and wireless process control networks (also referred to interchangeably herein as “process control communication networks,” “process control data networks,” “industrial networks,” “industrial communication networks,” or “industrial data networks”) to send and receive process control messages (e.g., data, commands, statuses, and the like) to and from various components, devices, and/or nodes to thereby control an industrial process. For example, a process control system (PCS) within an industrial environment may utilize the one or more process control wireless networks, which may be mesh wireless networks, to transmit and receive process control and other related messages. Components, devices, and/or nodes within the industrial environment may transmit messages via the one or more wireless networks, typically by utilizing a standardized protocol that is particularly designed for industrial control applications. That is, the industrial wireless protocol utilized by an industrial wireless communication network enables the timing and delivery of process control messages to and from receiving and sending nodes in industrial environments so that nodes may operate on the message contents within specified time intervals to control respective portions of the process. Specifically, the delivery of process control messages via the wireless network is scheduled and controlled across the network so that the industrial process does not become unstable and the wireless network does not become overloaded and thereby cause errors, faults, uncontrolled behaviors, and in some cases, dangerous consequences such as explosions, leaks, fires, and the like, which may lead to loss of equipment and more importantly, loss of human life. An example of such a commonly utilized wireless industrial protocol is WirelessHART®; however, any suitable wireless protocol which supports the scheduling and time-synchronization of the delivery and reception of process control messages between nodes of the network to control an industrial process and thereby manage risk within the industrial environment may be utilized. Generally speaking, a wireless network manager generates or creates a network schedule for the industrial wireless communication network, and the network manager provides respective portions of the schedule to nodes of the wireless network so that each node is configured to access the wireless network at respective scheduled or designated times or time slots to send and/or receive process control related messages, and so that communications between nodes of the industrial wireless communications network are delivered in a coordinated and controlled manner across the network.

The present disclosure provides systems and methods for remotely monitoring, controlling, and otherwise communicating with circuit breakers associated with luminaires, field devices, equipment, and/or other devices in an industrial environment, such as a process control plant. These circuit breakers may be positioned in an explosion-proof housing in the industrial environment using the process control wireless network (e.g., using WirelessHART® mesh technology), and the systems and methods provided herein allow for remotely monitoring, controlling, and otherwise communicating with the circuit breakers without the need to pull out any data cables or manually open a door of the explosion-proof housing. Using the process control wireless network (e.g., a WirelessHART® network), the performance of the circuit breakers may be remotely monitored in real-time to ensure powered equipment is operating to expected specifications. For instance, key circuit breaker events, such as overtemperature events, trip events, safety incidents, etc. may be reported to remote devices via the process control network. Furthermore, the configuration of the circuit breakers within the explosion-proof housing may be adjusted, and/or calibration sequences, as well circuit breaker open sequences, for the circuit breakers may be run remotely using the process control network. Additionally, the circuit breakers may be remotely operated based on control commands received via the process control network, e.g., such that one or a group of circuit breakers are opened in the event of an emergency or other safety incident detected by the centralized control system.

Advantageously, the techniques provided herein for remotely communicating with the circuit breaker and connected systems in the industrial environment via the process control network avoid costs and time needed for obtaining hot work permits within industrial and hazardous facilities, and reduce the need for workers to expose themselves to potential safety risks associated with entering potentially hazardous areas of the facility or service open high voltage panels and equipment. Furthermore, the techniques provided herein for remotely communicating with the circuit breaker and connected systems in the industrial environment via the process control network reduce the need data cables to be added through hazardous location rated areas of the facility. Moreover, communicating with the circuit breakers via the process control network enables the connected breaker data and facility sensor data to be communicated on shared wireless infrastructure such as gateways, servers, and other based devices in the network, and helps the mesh network quality at the plant by acting as live node. Advantageously, the connected breaker and enclosure may be self-contained, and further data cabling or external power sources may not be required, enabling faster and lower cost installations for the end application.

In an embodiment, a system in a process control plant is provided, the system comprising: one or more circuit breakers positioned within an explosion-proof housing; one or more devices positioned external to the explosion-proof housing; and a controller associated with the one or more circuit breakers, the controller being positioned within the explosion-proof housing, connected, via a wired communication interface, to the one or more circuit breakers via one or more wired communication links, and connected, via a wireless communication interface, to the one or more devices via one or more wireless communication links, wherein the one or more wireless communication links have lower bandwidth than the one or more wired communication links, the controller including: one or more processors; the wired communication interface; the wireless communication interface; and one or more memories storing a set of computer-executable instructions that, when executed, by the one or more processors, cause the controller to: receive, from the one or more circuit breakers via the one or more wired communication links, data associated with the operation of the one or more circuit breakers; generate one or more messages based on the data associated with the operation of the one or more circuit breakers; and send, via the one or more wireless communication links, the one or more messages to the one or more devices positioned external to the explosion-proof housing.

In another embodiment, a controller positioned within an explosion-proof housing is provided in a process control system and associated with one or more circuit breakers within the explosion-proof housing, the controller being connected, via a wired communication interface, to the one or more circuit breakers via one or more wired communication links, and connected, via a wireless communication interface, to one or more devices positioned external to the explosion-proof housing via one or more wireless communication links, wherein the one or more wireless communication links have lower bandwidth than the one or more wired communication links, the controller including: one or more processors; the wired communication interface; the wireless communication interface; and one or more memories storing a set of computer-executable instructions that, when executed, by the one or more processors, cause the controller to: receive, from the one or more circuit breakers via the one or more wired communication links, data associated with the operation of the one or more circuit breakers; generate one or more messages based on the data associated with the operation of the one or more circuit breakers; and send, via the one or more wireless communication links, the one or more messages to the one or more devices positioned external to the explosion-proof housing.

In still another embodiment, a method implemented by a controller within an explosion-proof housing in a process control system is provided, the method comprising: receiving, from one or more circuit breakers within the explosion-proof housing, via one or more wired communication links, data associated with the operation of the one or more circuit breakers; generating one or more messages based on the data associated with the operation of the one or more circuit breakers; and sending, via one or more wireless communication links, the one or more messages to one or more devices positioned external to the explosion-proof housing, wherein the one or more wireless communication links have lower bandwidth than the one or more wired communication links.

### BRIEF DESCRIPTION OF THE DRAWINGS

FIG. 1 illustrates an example industrial environment in which circuit breakers in an explosion-proof housing may communicate wirelessly (e.g., using WirelessHART®) for health and/or performance monitoring by utilizing the systems, methods, luminaire nodes, and/or techniques of the present disclosure, in accordance with some embodiments provided herein.

FIG. 2 is a block diagram of an example wireless communication system (e.g., using WirelessHART®) as may be used by circuit breakers in an explosion-proof housing positioned within the exemplary industrial environment of FIG. 1, in accordance with some embodiments provided herein.

FIG. 3 is a flow diagram of an exemplary method via which circuit breakers in an explosion-proof housing (e.g., as shown at FIG. 2) may communicate wirelessly (e.g., using WirelessHART®) in an industrial environment such as the exemplary industrial environment of FIG. 1, for health and/or performance monitoring, in accordance with some embodiments provided herein.

### DETAILED DESCRIPTION

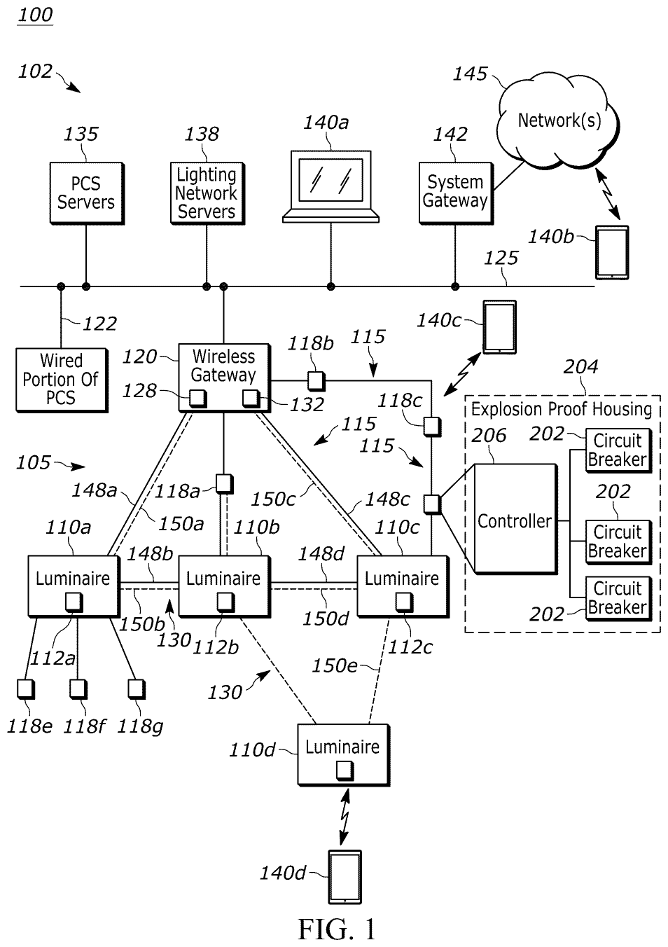

FIG. 1 illustrates an example industrial environment 100 in which embodiments of the systems, methods, equipment, luminaires, field devices, and techniques described herein may be implemented. In some situations, the example industrial environment may be disposed within a hazardous environment 100, such as an industrial process plant, a manufacturing facility, an oil refinery, a power-generating system, a mine, etc. including various components (such as communication networks, field devices such as process control devices, equipment, other devices, etc.). As interchangeably utilized herein, the terms “luminaire,” lighting unit”, and “light fixture” generally refer to an electrically powered component which operate to supply general or ambient light and/or task or focused light in the portion of the electromagnetic spectrum that is visible to the human eye, e.g., from about 380 to 740 nanometers. As shown in FIG. 1, the industrial environment 100 includes a back-end environment 102 and a field environment 105. In some industrial environments 100, such as those of an industrial process plant, a manufacturing facility, an oil refinery, a power-generating system, a mine, etc., the field environment 105 is a hazardous environment. Accordingly components disposed within the hazardous field environment 105 (e.g., luminaires, communication network components, field devices such as process control devices, equipment, etc.) must comply with all standards and/or regulatory rules that are applicable to the particular hazardous environment in which they are disposed to limit undesirable and/or dangerous effects of thermal and/or electrical energy generated during both their normal use and maintenance, as well as during fault conditions.

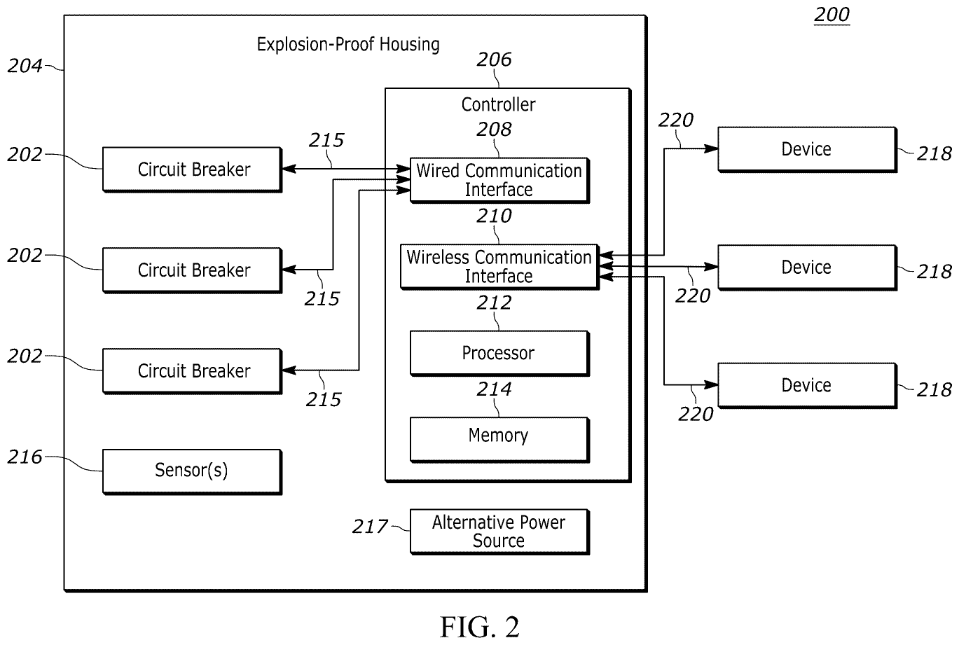

As shown in FIG. 1, three luminaires 110a, 110b, 112c which are configured according to one or more of the techniques described herein are disposed within the field environment 105. That is, each of the luminaire nodes 110a, 110b, 110c is a luminaire node. For example, each of the luminaire nodes 110a, 110b, 110c is respectively configured 112a, 112b, 112c (e.g., via hardware and/or computer-executable instructions and configurations stored on memories) to provide illumination, support maintaining process control or industrial wireless network reliability and/or connectivity, to perform other actions and techniques related thereto as described herein. In FIG. 1, each of the luminaire nodes 110a, 110b, 110c is a respective node of a wireless process control network 115 (link of which are denoted in FIG. 1 by the solid lines), where the wireless process control network 115 also includes other wireless nodes 118a-118f, a wireless gateway 120, and one or more controllers 206 (which may serve as additional nodes of the wireless process control network 115) associated with respective circuit breakers 202 in respective explosion-proof housings 204, discussed in greater detail below with respect to FIG. 2. In an embodiment, the wireless process control network 115 may be a wireless mesh network which utilizes a time-synchronized wireless protocol. The wireless nodes 118a-118f may be, for example, wireless field devices, wireless adaptors servicing respective wired field devices, routers, and/or other process control devices of a process control system (PCS). As illustrated in FIG. 1, process control devices 118e-118f are communicatively connected to the rest of the wireless network 115 via the luminaire node 110a, so that any process control related messages are routed to and from devices 118d-118f via the luminaire node 110a. Process control device 118d is communicatively connected to the wireless network 115 via both process control device 118c and via luminaire node 110c.

The wireless gateway 120 communicatively connects the wireless process control network 115 with the back-end environment 102 and/or other wired portions 122 of the process control system via a data highway or backbone 125, which may be an Ethernet, broadband fiber optic, or any suitable type or types of wired backbone(s). The wired portions 122 of the process control system may be disposed at least in part in the field environment 105 of the industrial environment 100, and may include, for example, controllers, I/O devices, marshalling equipment, wired field devices, and/or other types of wired process control devices. As such, each of the luminaire nodes 110a, 110b, 110c is included in the wireless network 115 of a process control system which includes the wireless portion 115 and a wired portion 122 disposed in the field environment 105, where the process control system operates to control an industrial process within the industrial environment 100. Thus, each luminaire 110a, 110b, 110c may be configured 112a, 112b, 112c to support maintaining the reliability of the wireless process control network 115.

As mentioned above, the wireless process control network 115 typically utilizes a time-synchronized wireless protocol such as WirelessHART® or other suitable wireless protocol to deliver control, data, and other types of messages between wireless nodes. Accordingly, the network 115 includes a wireless network manager 128 which, as denoted in FIG. 1, is included in the wireless gateway 120. (In other embodiments, though, the wireless network manager 128 may be a separate node of the network 112 and not integral with the wireless gateway 120.) As previously discussed, the wireless network manager 128 performs administrative and coordination tasks related to the process control wireless network 115, such as generating, re-organizing, updating, and administrating a network schedule, distributing respective portions of the network schedule to respective nodes, managing time-synchronization among wireless nodes, delivering messages between the wireless portion 115, the wired portion 122, and/or the back-end environment 102 of the process control network, and the like.

In FIG. 1, at least a portion or an entirety of the lighting network 130 may be a wireless mesh network, and in some embodiments, at least a portion of the wireless mesh network utilized by the lighting network 130 and at least a portion of the wireless mesh network utilized by the wireless process control network 115 may intersect and include the same links, nodes, etc. In some embodiments, the lighting network 130 (or wireless portion thereof) may utilize a time-synchronized wireless protocol such as WirelessHART® or other suitable wireless protocol to deliver lighting commands, instructions, and/or administrative information between lighting network nodes. In some configurations, the time-synchronized wireless protocol utilized by the lighting network 130 and the time-synchronized wireless protocol utilized by the wireless process control network 115 is the same protocol. In these configurations, both the wireless lighting network 130 and the wireless process control network 115 may be under the direction of the network manager 128, e.g., for scheduling, time synchronization, and other such purposes.

The luminaire nodes 110a, 110b, 110c and the luminaire 110d of the lighting network 130 operate to coordinate and control illumination within the industrial environment 100, as well as to perform other tasks related to providing illumination, e.g., by sending and receiving lighting control, data, and other types of messages via the lighting network 130. In embodiments, the lighting network 130 includes a lighting controller 132 which coordinates lighting/illumination activities of the lighting network 130 and administration thereof. In FIG. 1, the lighting controller 132 is illustrated 132 as being included in the wireless gateway 120; however, the lighting controller 132 may be included in any desired node of the lighting network 130, including a stand-alone in embodiments, and the lighting controller 132 typically is communicatively connected to the data highway 125 or another data highway. The lighting controller 132 may be in communicative connection with the network manager 128, and in some embodiments, the lighting controller 132 and the network manager 128 are an integral unit (not shown).

In the example industrial environment 100 of FIG. 1, the lighting network 130 is depicted as a wireless network which utilizes the time-synchronized protocol of the wireless network 115, and as such the luminaire nodes 110a, 110b, 110c and the luminaire 110d are communicatively connected with the back-end environment 102 via the wireless gateway 120 and the data backbone 125, e.g., via the same wireless gateway 120 and backbone 125 utilized by the wireless process control network 115. That is, at least a portion of the wireless process control network 115 and at least a portion of the lighting network 130 (e.g., nodes, links, gateway, etc.) intersect or are commonly utilized by both networks 115, 130 and are under the administrative networking purview of the network manager 128; however, this is just for ease of illustration and not for limitation purposes. For example, in other embodiments (not shown), the wireless process control network 115 and the lighting system network 115 may commonly utilize less or more components, and in still other embodiments (also not shown), the wireless lighting network 130 may be communicatively connected to the back-end environment 102 via its own, independent gateway and/or its own data backbone that are separate and different from the gateway 120 and the backbone 122, and may optionally may utilize its own network manager. Further, it is noted that although lighting network 130 is illustrated in FIG. 1 as being a wireless network, the lighting network 130 may be implemented by any number and/or combination of wired and/or wireless links and networking techniques, in embodiments.

The back-end environment 102 of the industrial environment 100 is protected from the harsh conditions of the field environment 105, and as such, various components of back-end may be safely disposed in the back-environment 102. For example, one or more back-end servers 135 of the process control system (PCS) may be disposed in the back-end environment 102, and may provide functionalities which support the real-time operations of the PCS such as configuration, data historian, analytics, reporting, etc. Additionally, one or more back-end servers 138 of the lighting network 130 may be disposed in the back-end environment, and may provide functionalities to support the coordinated illumination provided by the lighting network 130, such as configuration, control instructions, data historian, analytics, reporting, etc. It is noted that although the PCS back-end servers 135 and the lighting network back-end servers 138 are illustrated in FIG. 1 as being independent sets of servers, in some embodiments (not shown), at least a portion of the PCS back-end servers 135 and at least a portion of the lighting network servers 138 may be implemented as one or more integral servers. Further, in embodiments, at least a part of the PCS back-end servers 135 and/or at least a part of the lighting network servers 138 may be physically disposed in locations which are physically remote from the environment 100, such as at remote server banks, in a cloud computing system, etc.

The back-end environment 102 of the industrial environment 100 may also include one or more locally or remotely disposed user interface devices 140a-140d, which may include locally or remotely disposed computing devices, such as desktops, laptops, tablets, phones, smart devices, connected vehicle devices, and/or other types of Personal Electronic Devices (PEDs). For example, one or more user interface devices 140a utilized respectively by operators and/or by configuration engineers of the process control system and/or of the lighting network 130 may be locally connected in a wired manner to the data highway 125. One or more user interface devices 140b may be utilized respectively by operators and/or by configuration engineers of the process control system and/or of the lighting network 130 may be disposed remotely from the industrial environment site 100, and may be communicatively connected to the data highway 125 via a system gateway 142 and one or more public and/or private communications or data networks 145, for example. Additionally or alternatively, one or more user interface devices 140c, 140d may be utilized by personnel located within the field environment 105 of the industrial environment 100, where the devices 140c, 140d may be communicatively connected to respective process control and/or lighting systems directly via local means, e.g., via wireless network 115, a wireless portion of the lighting network 130, or other suitable wireless links and/or networks. For instance, one or more of the user interface devices 140c, 140d may be communicatively connected to the process control network 115 or nodes thereof and/or to the lighting network 130 or nodes thereof remotely via networking means, e.g., by utilizing a generic last-mile wireless local network (e.g., Wi-Fi, cellular, short-range wireless protocols, etc.) proximate to or included in the field environment 105, the one or more public and/or private networks 145, and the system gateway 142.

Further, as shown in FIG. 1, each user interface device 140a-140d may execute applications, thin clients, or other types of user interfaces, each of which services the process control system, the lighting system, or both systems. For example, the user interface device 140a which is physically disposed in the back-end environment 102 of the industrial environment 100 may include (and execute) one or more process control system-specific user interface applications and/or one or more lighting system-specific user interface applications. In another example, a remote user interface device 140b (e.g., which is utilized by remotely located personnel) may execute one or more applications, thin clients, etc. corresponding to one or more process control system user interfaces, one or more lighting system interfaces, or both. In still another example, user interface device 140c is configured to only service the process control system and not the lighting system, and thus executes process control user interfaces (e.g., which may communicate with the process control system via wireless network 115) and not lighting system user interfaces. User interface device 140d is configured to service only the lighting system and not the process control system, and thus executes lighting system user interfaces (e.g., which may communicate with the lighting system via the lighting network 130) and not process control system user interfaces.

While the industrial environment 100 shown in FIG. 1 is discussed with respect to luminaire nodes as one example, industrial environments implementing the techniques provided herein may not include luminaires in some embodiments, or may include luminaires that do not necessarily serve as nodes in the industrial environment in some embodiments. Various other devices (such as field devices, process control devices, other devices, etc.) within the industrial environment may serve as nodes in some embodiments. Moreover, nodes may be connected to various networks, which may or may not include a lighting network, within the industrial environment in some embodiments.

FIG. 2 is a block diagram of an example wireless communication system 200 as may be used by circuit breakers in an explosion-proof housing positioned within the exemplary industrial environment of FIG. 1, in accordance with some embodiments provided herein.

As shown in FIG. 2, the system 200 may include one or circuit breakers 202 and a controller 206, and one or more sensors 216 positioned within an explosion-proof housing 204. For instance, each of the circuit breakers 202 may include independent power lines connected to various of the devices of the industrial system shown at FIG. 1. When a respective circuit breaker 202 is closed, power may be provided to devices such as field devices in the industrial environment, equipment in the industrial environment (e.g., pipe heat tracing, pumps and fans used throughout the industrial facility), other devices in the industrial environment, etc., to which the circuit breaker 202 is connected via the independent power lines, and when the respective circuit breaker is opened, power may cease to be provided to the devices to which the circuit breaker 202 is connected via the independent power lines.

The explosion-proof housing 204 may be, for instance, an explosion-proof metallic enclosure rated for hazardous area installations, such as a National Electric Code (NEC) explosion-proof enclosure. With appropriate electronic design provisions for hazardous locations, NEC Class I Div 2, and various International Electrotechnical (IEC) protection systems may be employed to enable deployment in remote hazardous areas, in some examples. The controller 206 may include a wired communication interface 208, a wireless communication interface 210, one or more processors 212, and one or more memories 214.

The wired communication interface 208 may be connected to each of the circuit breakers 202 via respective wired communication links 215, and the controller 206 may communicate with each of the circuit breakers 202 via the wired communication links 215. For instance, the circuit breakers 202 may each be communicatively connected to the wired communication interface 208 via a multi-drop serial communication protocol. Generally speaking, the circuit breakers 202 may send data associated with the operation of respective circuit breakers 202 to the controller 206 via the wired communication links 215. Additionally, in some examples, the controller 206 may send control commands to respective circuit breakers 202 via the wired communication links 215.

The wireless communication interface 210 may be communicatively connected to one or more devices 218 (including one or more luminaires 110a-110d, wireless nodes 118a-118f within the industrial plant, wireless gateways 120, user devices 140c, 140d, etc., as discussed with respect to FIG. 1) that are positioned external to the explosion-proof housing 204 via respective wireless communication links 220 over the wireless process control network 115 discussed above with respect to FIG. 1.

Generally speaking, the wireless communication links 220 may have lower bandwidth than the wired communication links 215. In particular, the wireless communication interface 210 may be an explosion-proof radio module (e.g., a 2.4 Ghz radio) configured to act as a node of a network in the industrial system, and may communicate with the devices 218 via the same wireless process control network 115 that the devices 218 use to wirelessly communicate with one another in the industrial environment (e.g., a WirelessHART® network, a ISA 100 wireless network, an IO-link wireless network, etc.). In some examples, the wireless communication interface 210 may further include Bluetooth® communication capabilities, and may communicate with certain devices 218 via Bluetooth®, including via Bluetooth® mesh.

The wireless communication interface 210 may allow the controller 206 to be a node of the wireless process control network 115, i.e., such that the controller 206 may serve as a repeater for messages sent within the process control network 115. For instance, the controller 206 may receive a message from a first device 218 within the industrial plant via a respective wireless communication link 220 over the wireless process control network 115, and send that message to another device 218 within the industrial plant via another respective wireless communication link 220 over the wireless process control network 115.

In some examples, the controller 206 may generate one or more messages based on the data that the controller 206 receives from the one or more circuit breakers 202, and may send the generated messages to respective devices 218 via respective wireless communication links 220. Moreover, in some examples, the controller 206 may receive control commands for one or more of the circuit breakers 202 from the devices 218 via respective wireless communication links 220, and may in turn send the control commands to respective circuit breakers 202 via the respective wired communication links 215, as discussed above.

The one or more sensors 216, which may include temperature sensors, humidity sensors, or other sensors configured to measure the conditions within the explosion-proof housing, may communicate with the controller 206 via one or more of the wired communication interface 208 (e.g., using a serial communication protocol such as I2C, SPI, etc.) or the wireless communication interface 210, or via another communication interface, in various embodiments. In some examples, the controller 206 may generate control commands for various circuit breakers 202 based at least partially on data captured by the one or more sensors 216.

In some examples, the system 200 may further include a 12/24 V Safety Extra Low Voltage (SELV) power supply and an intrinsically safe (IS) barrier, with the 12/24V SELV power used to power the circuit breakers 202 while the IS barrier converts this to 3V IS for the wireless communication interface 210. Moreover, in some examples, the system 200 may further include an alternative power source 217 (such as a battery pack and charging module) within the explosion-proof housing 204 to allow the circuit breakers 202, controller 206, wired communication interface 208, and wireless communication interface 210 to continue critical functions in an event of AC mains outage (e.g., communication functions to ensure the integrity of the wireless process control network 115), and to report such outage incidents to the control system.

The memories 214 may include non-transitory, computer-readable instructions that, when executed by the one or more processors 212, cause the controller 206 perform the operations discussed above (and, in some examples, additional/alternative operations). For instance, the instructions stored on the memories 214 may cause the controller 206 to receive real-time data from the circuit breakers 202 positioned within the explosion-proof housing 204, and/or from the sensors 216 positioned within the explosion-proof housing 204, at the wired communication interface 208 via the wired links 215. Furthermore, the instructions stored on the memories 214 may cause the controller 206 to analyze the real-time data from the circuit breakers 202 and/or from the sensors 216, and generate messages based on the real-time data from the circuit breakers 202 and/or from the sensors 216. Additionally, in examples in which an alternative power source 217, such as a battery pack is included within the explosion-proof housing 204, the instructions stored on the memories 214 may further cause the controller 206 to analyze real-time data from the battery pack 217 to determine that an AC mains power outage has occurred, and generate messages based on the real-time data including an indication of the AC mains power outage.

In some examples, analyzing the real-time data from the circuit breakers 202 and/or from the sensors 216 may include identifying breaker trip events, as well as determining one or more fault conditions that triggered each breaker trip event. For example, analyzing the real-time data from the circuit breakers 202 and/or from the sensors 216 may include determining a primary electrical fault that triggered a breaker trip event. For instance, the controller 206 may identify a time stamp associated with a breaker trip event and may use this time stamp to determine a fault condition that triggered the breaker trip event (e.g., based on a time stamp associated with the fault condition being shortly prior to the time stamp associated with the breaker trip event). Moreover, the controller 206 may identify time stamps associated with various different breaker trip events for different circuit breakers 202, and may use these time stamps to determine relative timing, the root cause load fault initiating the trip events, and/or whether multiple breaker trip events may be related to one another. For example, an upstream power bus circuit breaker feeding multiple downstream breakers may be tripped when one of the downstream breakers trips, and the time stamps associated with each trip event may allow the controller 206 to identify the downstream breaker trip event as a possible cause of the upstream power bus circuit breaker trip event. As another example, a time stamp for a sensor condition (such as, e.g., an overheat condition, a moisture/water condition, etc.) as captured by one of the sensors 216 may indicate that the sensor condition occurred shortly prior to several different breaker trip events, and the controller 206 may identify the sensor condition as a possible cause of the breaker trip events. In some examples, the controller 206 may be configured to use this time stamp data to align event timing across multiple such systems 200, or may send this time stamp data to another system which in turn receives time stamp data from multiple such systems 200 and may use the time stamp data to align event timing across multiple such systems 200.

Moreover, in some examples, analyzing the real-time data from the circuit breakers 202 and/or from the sensors 216 may include performing machine learning analytics on the raw data generated by the circuit breakers 202 and/or the sensors 216 (and/or the battery pack 217) to generate the messages. For example, a machine learning model may be trained using historical sensor data associated with historical circuit breakers during historical instances of tripping or failure, and/or various historical device health conditions, and, once trained, may be configured to predict future instances of tripping or failure, and/or various device health conditions for a current circuit breaker based on current sensor data associated with the circuit breaker. For instance, the raw data generated by the circuit breakers 202 and/or the sensors 216 (and/or the battery pack 217) may be analyzed to predict whether one or more of the circuit breakers 202 will trip or otherwise fail based on the current sensor data (i.e., within a certain period of time, given that sensor conditions continue), and/or to determine various parameters related to the health of the circuit breakers 202 and the system as a whole, including, for instance, a life expectancy of one or more of the circuit breakers 202, the sensors 216, the battery pack 217, etc.

Additionally, in some examples, analyzing the real-time data from the circuit breakers 202 and/or from the sensors 216 may include analyzing a measured power usage by a device in the industrial environment 100 (such as, e.g., a luminaire) and comparing the measured power usage to power usage that is estimated based on the output of the device (e.g., estimated based on the type of light, set point, measured brightness, etc., for the luminaire) to identify discrepancies or abnormalities, or sending an indication of the measured power usage as a message to another device that may in turn compare the measured power usage to an estimated power usage to identify a discrepancy or abnormality.

Furthermore, in some examples, these messages may be alert or alarm messages indicating, e.g., a detected or predicted failure of one or more of the circuit breakers 202, a detected or predicted safety hazard, a detected or predicted power outage, etc. For example, the controller 206 may generate messages associated with detected or predicted water ingress, high internal temperature, and/or other environmental conditions within the explosion-proof housing 204. Furthermore, the controller 206 may generate messages associated with the detection or the prediction of the circuit breakers 202 approaching a trip limit, in some cases before the trip limit is reached. Additionally, the controller 206 may generate messages indicating that services is needed for one or more of the circuit breakers 202, the sensors 216, the battery pack 217, etc., or any other elements of the system 200. Moreover, the instructions stored on the memories 214 may cause the controller 206 to send (in real-time or near-real-time) the generated messages to various devices 218 outside of the explosion-proof housing 204 in the industrial environment, from the wireless communication interface 210, via the wireless links 220. In some cases, the controller 206 may send the generated messages to a luminaire, which may in turn generate a blink sequence corresponding to the identified alert, alarm, or message. Moreover, the instructions stored on the memories 214 may cause the controller 206 to send certain messages (e.g., messages related to important events, safety incidents, etc.) to an edge gateway device within the industrial environment, which may in turn send the messages to devices outside of the industrial environment (e.g., user devices associated with operators outside of the industrial environment).

Additionally, the instructions stored on the memories 214 may cause the controller 206 to receive requests for circuit breaker data from one or more of the devices 218, at the wireless communication interface 210, via the wireless links 220. For instance, the instructions stored on the memories 214 may cause the controller 206 to retrieve or fetch the requested data from the circuit breakers 202 and/or the sensors 216, at the wired communication interface 208 via the wired communication links 215. Furthermore, the instructions stored on the memories 214 may cause the controller 206 to send the retrieved or fetched circuit breaker data to the one or more requesting devices 218, from the wireless communication interface 210 via the wireless communication links 220.

Furthermore, in some examples, the instructions stored on the memories 214 may cause the controller 206 to receive control commands, updated or modified configurations, and/or calibration sequences for one or more of the circuit breakers 202 (i.e., for one circuit breaker 202 or for a group of circuit breakers 202) from the devices 218, at the wireless communication interface 210, via the wireless links 220. For example, a device 218 in the industrial environment may detect an issue affecting itself or another device 218 in the industrial environment, or a safety issue affecting individuals who may be present in the industrial environment, and may send, to the controller 206 at the wireless communication interface 210, via a wireless link 220, a control command for a circuit breaker 202 associated with the affected device to be opened or closed. As another example, an operator may provide input via a user interface of a device 218 in the industrial environment that causes the device 218 to send, to the controller 206 at the wireless communication interface 210, via a wireless link 220, a control command for a particular circuit breaker 202 or group of circuit breakers 202 to be opened or closed.

In response to receiving control commands, updated or modified configurations, and/or calibration sequences, the controller 206 may, for instance, send a control command to one or more of the circuit breakers 202 (i.e., to one circuit breaker 202 or for a group of circuit breakers 202), and/or may adjust, update, and/or otherwise modify a configuration associated with one or more of the circuit breakers 202 (i.e., associated with one circuit breaker 202 or associated with a group of circuit breakers 202), and/or may send a calibration sequence to be run by one or more of the circuit breakers 202 (i.e., to be run by one circuit breaker 202 or to be run by a group of circuit breakers 202), from the wired communication interface 208 via the wired communication links 215. Consequently, the one or more circuit breakers 202 may operate according to the control command, and/or may operate according to the updated/modified configuration, and/or may run the calibration sequence, etc. For instance, the one or more circuit breakers may open or close the circuit in response to the received control commands.

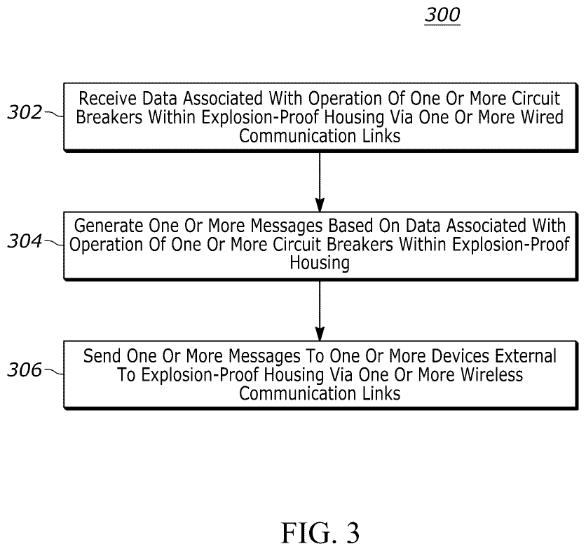

Additionally, in some examples, the instructions stored on the memories 214 may cause the controller 206 to execute any of the steps of the method 300 discussed below with respect to FIG. 3.

FIG. 3 is a flow diagram of an exemplary method 300 via which circuit breakers in an explosion-proof housing (e.g., as shown at FIG. 2) may communicate wirelessly (e.g., using WirelessHART®) in an industrial environment such as the exemplary industrial environment of FIG. 1, for health and/or performance monitoring, in accordance with some embodiments provided herein. At block 302, the method 300 may include receiving, from one or more circuit breakers within the explosion-proof housing, via one or more wired communication links, data associated with the operation of the one or more circuit breakers. At block 304, the method 300 may include generating one or more messages based on the data associated with the operation of the one or more circuit breakers. For instance, generating the messages may be based on data captured by one or more sensors positioned within the explosion-proof housing via the one or more wired communication links. For instance, the sensors may include temperature sensors, humidity sensors, etc. Generating the messages may include processing raw data from one or more circuit breakers (or sensors associated therewith) and preparing consolidated data from one or more circuit breakers to be published on the wireless network. At block 306, the method 300 may include sending, via one or more wireless communication links, the one or more messages to one or more devices positioned external to the explosion-proof housing, wherein the one or more wireless communication links have lower bandwidth than the one or more wired communication links. For instance, the devices may include field devices of the process control system.

In some embodiments, the method 300 includes one or more alternate and/or additional actions other than those shown in FIG. 3. For instance, in some examples, the method 300 may further include receiving, from the one or more devices via the one or more wireless communication links, one or more control commands for the one or more circuit breakers, and sending the one or more control commands for the one or more circuit breakers to the one or more circuit breakers via the one or more wired communication links.

The following additional considerations apply to the foregoing discussion.

A user interface device, personal electronic device, or portable computing device, such as the devices 140b, 140c, 140d, which may operate in conjunction with embodiments of the luminaire node disclosed herein, e.g., luminaire 110a, 110b, 110c, 200, can be any suitable device capable of wireless communications such as a smartphone, a tablet computer, a laptop computer, a wearable or body-borne device, a drone, a camera, a media-streaming dongle or another personal media device, a wireless hotspot, a femtocell, or a broadband router. Further, the portable computing device and/or embodiments of the disclosed luminaire can operate as an internet-of-things (IoT) device or an Industrial internet-of-things (IIoT) device.

Certain embodiments are described in this disclosure as including logic or a number of components or modules. Modules may be software modules (e.g., code stored on non-transitory machine-readable medium) or hardware modules. A hardware module is a tangible, non-transitory unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for the circuit breakers 202, explosion-proof housing 204, controller 206, etc., through the principles disclosed in this disclosure. Thus, while this document illustrates and describes particular embodiments and applications, the disclosed embodiments are not limited to the precise construction and components disclosed. Various modifications, changes and variations, which will be apparent to those of ordinary skill in the art, may be made in the disclosed arrangement, operation and details of the method, and apparatus without departing from the spirit and scope defined in the appended claims.

1. A system in a process control plant, the system comprising:
one or more circuit breakers positioned within an explosion-proof housing;
one or more devices positioned external to the explosion-proof housing; and
a controller associated with the one or more circuit breakers, the controller being positioned within the explosion-proof housing, connected, via a wired communication interface, to the one or more circuit breakers via one or more wired communication links, and connected, via a wireless communication interface, to the one or more devices via one or more wireless communication links, wherein the one or more wireless communication links have lower bandwidth than the one or more wired communication links, the controller including:
one or more processors;
the wired communication interface;
the wireless communication interface; and
one or more memories storing a set of computer-executable instructions that, when executed, by the one or more processors, cause the controller to:
receive, from the one or more circuit breakers via the one or more wired communication links, data associated with the operation of the one or more circuit breakers;
generate one or more messages based on the data associated with the operation of the one or more circuit breakers; and
send, via the one or more wireless communication links, the one or more messages to the one or more devices positioned external to the explosion-proof housing.

2. The system of claim 1, wherein the computer-executable instructions, when executed by the one or more processors, further cause the controller to:
receive, from the one or more devices via the one or more wireless communication links, one or more control commands for the one or more circuit breakers; and
send the one or more control commands for the one or more circuit breakers to the one or more circuit breakers via the one or more wired communication links.

3. The system of claim 1, further comprising one or more sensors positioned within the explosion-proof housing, wherein the controller is connected, via the wired communication interface, to the one or more sensors via the one or more wired communication links, and wherein generating the one or more messages is further based on data captured by the one or more sensors.

4. The system of claim 3, wherein the one or more sensors include temperature sensors.

5. The system of claim 3, wherein the one or more sensors include humidity sensors.

6. The system of claim 1, wherein the one or more devices positioned external to the explosion-proof housing include one or more field devices of the process control plant.

7. The system of claim 1, further comprising a battery positioned within the explosion-proof housing, wherein the controller is connected, via the wired communication interface, to the battery via the one or more wired communication links, and wherein the battery is configured to provide power to the controller and to the one or more circuit breakers in mains power outages for the performance of critical functions.

8. A controller positioned within an explosion-proof housing in a process control system and associated with one or more circuit breakers within the explosion-proof housing, the controller being connected, via a wired communication interface, to the one or more circuit breakers via one or more wired communication links, and connected, via a wireless communication interface, to one or more devices positioned external to the explosion-proof housing via one or more wireless communication links, wherein the one or more wireless communication links have lower bandwidth than the one or more wired communication links, the controller including:
one or more processors;
the wired communication interface;
the wireless communication interface; and
one or more memories storing a set of computer-executable instructions that, when executed, by the one or more processors, cause the controller to:
receive, from the one or more circuit breakers via the one or more wired communication links, data associated with the operation of the one or more circuit breakers;
generate one or more messages based on the data associated with the operation of the one or more circuit breakers; and
send, via the one or more wireless communication links, the one or more messages to the one or more devices positioned external to the explosion-proof housing.

9. The controller of claim 8, wherein the computer-executable instructions, when executed by the one or more processors, further cause the controller to:
receive, from the one or more devices via the one or more wireless communication links, one or more control commands for the one or more circuit breakers; and
send the one or more control commands for the one or more circuit breakers to the one or more circuit breakers via the one or more wired communication links.

10. The controller of claim 8, wherein the controller is further connected, via the wired communication interface, to one or more sensors positioned within the explosion-proof housing via the one or more wired communication links, and wherein generating the one or more messages is further based on data captured by the one or more sensors.

11. The controller of claim 10, wherein the one or more sensors include temperature sensors.

12. The controller of claim 10, wherein the one or more sensors include humidity sensors.

13. The controller of claim 8, wherein the one or more devices positioned external to the explosion-proof housing include one or more field devices of the process control system.

14. The controller of claim 8, wherein the controller is further connected, via the wired communication interface, to a battery positioned within the explosion-proof housing via the one or more wired communication links, and wherein the battery is configured to provide power to the controller and to the one or more circuit breakers in mains power outages for the performance of critical functions.

15. A computer-implemented method implemented by a controller within an explosion-proof housing in a process control system, the method comprising:
receiving, from one or more circuit breakers within the explosion-proof housing, via one or more wired communication links, data associated with the operation of the one or more circuit breakers;
generating one or more messages based on the data associated with the operation of the one or more circuit breakers; and
sending, via one or more wireless communication links, the one or more messages to one or more devices positioned external to the explosion-proof housing, wherein the one or more wireless communication links have lower bandwidth than the one or more wired communication links.

16. The computer-implemented method of claim 15, further comprising:
receiving, from the one or more devices via the one or more wireless communication links, one or more control commands for the one or more circuit breakers; and
sending the one or more control commands for the one or more circuit breakers to the one or more circuit breakers via the one or more wired communication links.

17. The computer-implemented method of claim 15, wherein generating the one or more messages is further based on data captured by one or more sensors positioned within the explosion-proof housing via the one or more wired communication links.

18. The computer-implemented method of claim 17, wherein the one or more sensors include temperature sensors.

19. The computer-implemented method of claim 17, wherein the one or more sensors include humidity sensors.

20. The computer-implemented method of claim 17, wherein the one or more devices positioned external to the explosion-proof housing include one or more field devices of the process control system.

21.-22. (canceled)
